(19) United States
(12) Patent Application Publication
(10) Pub. No.: US 2012/0158602 A1
(43) Pub. Date: Jun. 21, 2012

(54) INTRA-ENTERPRISE INGREDIENT SPECIFICATION COMPLIANCE

(75) Inventors: Andrew J. Dolan, Arvada, CO (US); William R. Pape, Los Ojos, NM (US); Gary Nowacki, Exeter, NH (US)

(73) Assignee: Aginfolink Holdings, Inc., a BVI Corporation, Tortola (VG)

(21) Appl. No.: 12/969,814

(22) Filed: Dec. 16, 2010

(51) Int. Cl. G06Q 10/00

(52) U.S. Cl. 705/317

(57) ABSTRACT

Methods, systems, and apparatus, including computer programs encoded on computer storage media, for measuring intra-enterprise ingredient specification compliance. In one aspect, a method includes receiving a document pertaining to particular shipment of an ingredient from a supplier, automatically determining, from the document, a value or a range of values for each of one or more attributes associated with the ingredient, accessing a specification that indicates a value or a range of values for each attribute, comparing, for each attribute, the value or range of values from the document to the specification value or range of values for the attribute, to identify an extent to which the attribute in the particular shipment of the ingredient satisfies the specification; and automatically taking action on the shipment based on the extent to which the shipment satisfies the specification.

### BACKGROUND

This specification relates to supply chain management.

A certificate of analysis is a document that certifies the quality or purity of a shipment of a product that is moving, or that has moved, in a supply chain. An enterprise that receives multiple shipments a day, in some cases hundreds or even thousands of shipments a day, is likely to do little else with these documents than to discard them, or to place them in an archive.

### SUMMARY

According to one innovative aspect of the subject matter described by this specification, an enterprise can automatically analyze a certificate of analysis for a shipment of an ingredient before or after the shipment is received, to identify different quality or purity attributes associated with the ingredient in the shipment, and values associated with the identified attributes. This specification refers to the values that are automatically identified from a certificate of analysis as “certified values” or “certified attribute values.”

The certified values are compared to a specification that specifies attribute values that the enterprise requires to process the ingredient into a finished product. In some cases, the specification specifies attribute values that a supplier of the ingredient has contracted, promised or otherwise committed to provide in the shipment to the enterprise. This comparison may allow the enterprise to determine the extent to which the shipment satisfies or deviates from the specification and, by extension, the extent to which the supplier has honored or failed to live up to their commitments.

Depending on the nature or extent of any deviations between received attribute values and promised or required specification values, various actions may be taken on the shipment, or on future shipments from the supplier. In one example, a shipment of an ingredient that includes a certified value that significantly deviates from a specification value may be automatically returned to the supplier, before or after the shipment has arrived at the enterprise. Deviations between certified values and specification values may also be used to calculate risk scores that are specific to the supplier, the ingredient, the shipment, the attribute, or any combination thereof.

Further comparison of the certified values with actual attribute values that may be measured or generated by the enterprise may allow the enterprise to determine the extent to which the supplier-provided certificate of analysis is accurate. Such an analysis allows the enterprise to aggregate data across multiple suppliers, shipments, ingredients and attributes to generate a so-called “liars report” that measures the accuracy of the certified statements of various suppliers. Such a report may identify those suppliers, for instance, that overstate the attributes of the ingredients that they supply.

As used herein, an “ingredient” refers to a substance that forms part of a mixture or finished product, such as an agricultural product or food item. Example ingredients may include grains or particular types of grains, such as wheat flour. Other ingredients may include proteins, meat products, water, grains, lard, eggs, milk, syrups (such as corn syrups), sugar, spices, artificial or natural additives, or other substances. “Attributes” of an ingredient refer to a quality, character, characteristic or property of the ingredient, and may include, among others, a moisture content attribute, a pH attribute, a color attribute, a condition attribute, a date attribute, a count attribute, an age attribute, a calorie attribute, a supplier name attribute, a microbiological test attribute (such as for the existence of pathogens), or a debris free attribute.

Attributes are associated with values that specify an amount, quantity, or level of the attribute that occurs in a particular shipment of an ingredient. The attributes included on a certificate of analysis may be chosen by the supplier or by the enterprise. These values, referred to simply as “values,” or as “attribute values,” are certified by the supplier of the ingredient or their agent. Attribute values are specific to a particular shipment, and thus different shipments have different certificates of analysis that may show different attribute values.

A “specification” is an explicit set of requirements that is to be satisfied by a material, product, or service, as provided, for example, in a document such as a contract or a shipping invoice. The specification can specify values for different attributes that are to be satisfied, where these values are referred to as “specification values.” As used herein, a “shipment” refers to a quantity of a good, such as an ingredient, that are shipped together as part of a same lot.

According to another innovative aspect, the subject matter described in this specification may be embodied in methods that include the actions of receiving a document pertaining to particular shipment of an ingredient from a supplier, automatically determining, from the document, a value or a range of values for each of one or more attributes associated with the ingredient, accessing a specification that indicates a value or a range of values for each attribute, comparing, for each attribute, the value or range of values from the document to the specification value or range of values for the attribute, to identify an extent to which the attribute in the particular shipment of the ingredient satisfies the specification; and automatically taking action on the shipment based on the extent to which the shipment satisfies the specification.

Other embodiments of these aspects include corresponding systems, apparatus, and computer programs, configured to perform the actions of the methods, encoded on computer storage devices.

These and other embodiments may each optionally include one or more of the following features. For instance, the document is a certificate of analysis; attributes are quality attributes or purity attributes associated with the particular shipment of the ingredient; a risk score is calculated for one or more of the supplier, the ingredient, the particular shipment, and the attribute, based on the extent to which the attribute in the particular shipment of the ingredient satisfies the specification; automatically determining, from the document, a value or a range of values for each of one or more attributes associated with the ingredient further includes accessing a template that is specific to the supplier, wherein the template maps regions of the document to attribute values, and performing an optical character recognition process on the document using the template; the actions also include determining an actual value or range of values for one or more attributes, comparing the actual value or range of values to the value or range of values from the document, to identify an extent to which the value or range of values from the document deviates from the actual value, and generating a report that identifies the extent to which the value or range of values from the document deviates from the actual value; the attribute comprises a moisture content attribute; and/or comparing, for each attribute, the value or range of values from the document to the specification value or range of values for the attribute, further includes comparing the value or range of values from the document to an “out of spec, high” range of values, a “warning track, high” range of values, an “accept” range of values, a “warning track, low” range of values, and an “out of spec, low” range of values.

The details of one or more embodiments of the subject matter described in this specification are set forth in the accompanying drawings and the description below. Other potential features, aspects, and advantages of the subject matter will become apparent from the description, the drawings, and the claims.

### DESCRIPTION OF DRAWINGS

FIGS. 1 and 5 are diagrams of example systems.

FIG. 2 is an example flowchart.

FIG. 3 depicts an example certificate of analysis.

FIG. 4 is an example screenshot.

FIG. 6 shows an example of the calculation of risk scores for a sample shipment of an ingredient.

Like reference symbols in the various drawings indicate like elements.

### DETAILED DESCRIPTION

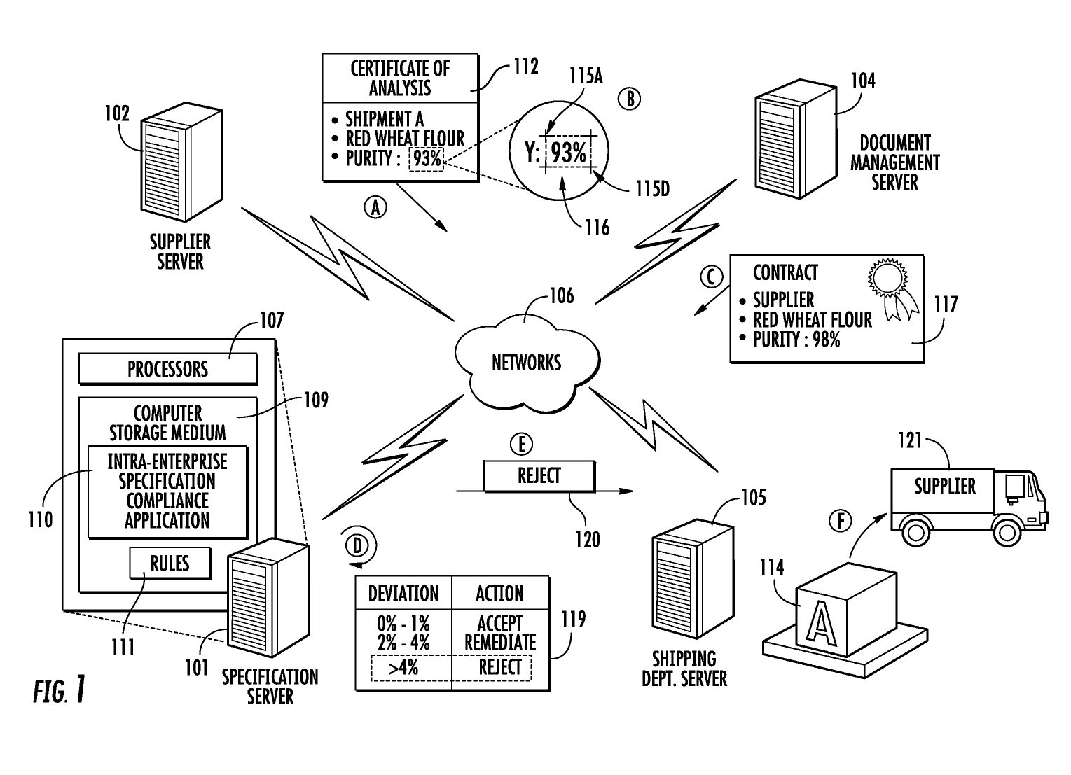

FIG. 1 is a diagram of an example system 100. The system 100 includes a specification compliance server 101, a document management server 104, and a shipment management server 105, all of which are accessibly by an enterprise that is receiving a shipment (referred to as “the enterprise” or “the recipient”). For example, the specification compliance server 101 may be used by the enterprise's quality assurance department, the document management server 104 may be used by the enterprise's legal department, and the shipment management server 105 may be used by the enterprise's shipping and receiving department.

The specification compliance server 101, the document management server 104, and the shipment department server 105 may be implemented on different servers, or the functionality of two or more of these servers can be combined on a single server or server system. Any one or more of these servers may be under the control of the enterprise itself, or they may be accessible to the enterprise over the networks 106. For instance, the specification compliance server 101, the document management server 104, and the shipment department server 105 may actually be servers that are controlled by a third party, and that host specification compliance software that is accessible to the enterprise under a “Software as a Service” (“SaaS”) subscription.

The system 100 also includes a supplier server 102 that is under the control of, or otherwise accessible to, a supplier of the shipment 114 of an ingredient, or of an agent of the supplier. Example agents may include independent testing agencies or laboratories, agencies that process certificates of analysis or compliance on behalf of the supplier, or shipping companies. The supplier server 102 obtains or generates certificates of analysis or, where certificates of analysis are not exchanged between the supplier and the enterprise, the supplier provides a data exchange service (e.g., a web service or portal) that allows the enterprise to access attribute values for a shipment 114. The supplier may be an immediate or direct supplier of the enterprise, or an indirect supplier.

Each of the specification compliance server 101, the supplier server 102, the document management server 104, and the shipment management server 105 may be a computing device, such as a server, a desktop or laptop computer, a tablet computer, a music player, an e-book reader, a consumer electronic product, an embedded system, or any other device that includes one or more computer processors and computer-readable storage media. Any one or more of the servers may instead represent an interface to a device or server that may or may not be under the control of the supplier or the enterprise. The servers 101 to 104 are in communication with each other over one or more networks 106. The networks 106 may include public computer networks, such as the Internet, private computer networks, such as corporate intranets, or any appropriate combination thereof.

The specification compliance server 101 includes one or more computer processors 107 and computer readable storage medium 109, upon which the specification compliance server 101 stores an intra-enterprise specification compliance application 110 and one or more sets of rules 111. The other servers may include similar hardware. Among other functions, the intra-enterprise specification compliance application implements the processes illustrated in FIG. 1 for determining the extent to which the shipment 114 satisfies or deviates from a specification, for initiating action on the shipment, and for calculating risk scores for suppliers, ingredients, shipments, and/or attributes.

FIG. 1 also illustrates an exemplary flow of data through the system 100 during states (a) through (f). The states (a) through (f) may occur in the illustrated sequence, or they may occur in a sequence that is different than is illustrated. During state (a), the supplier provides the enterprise with certificate of analysis 112, or provides the enterprise with access to information that would be included on a certificate of analysis.

The certificate of analysis 112 may be a physical document, i.e., on paper, or the certificate of analysis 112 may be an electronic document, i.e., a computer file such as a plaintext file, an eXtensible Markup Language (XML) file, a Portable Document Format (PDF) file, a markup language file, a comma separated value (CSV) file, or a word processor or spreadsheet file. The certificate of analysis 112 may be provided to the enterprise before, with, or after the delivery or attempted delivery of the shipment 114. For example, the certificate of analysis 112 may be stapled to the shipment 114 itself when the shipment is received by the enterprise, or may be provided to the enterprise electronically beforehand.

The certificate of analysis 112 may be provided in electronic form to the enterprise when the supplier server 102 establishes a communication session with the specification compliance server 101, and transmits the electronic certificate of analysis 112 to the specification compliance server 101. The electronic certificate of analysis 112 is received by the specification compliance server 101, and is stored on the computer-readable storage medium 109 in association with information that identifies the shipment 114, i.e., in a database or a table. A later query of the database or table using an identifier of the shipment will return the electronic certificate of analysis 112, or attribute values from the certificate of analysis 112.

Alternatively, a physical certificate of analysis 112 may be delivered in physical form from the supplier to the enterprise. The physical certificate of analysis 112 may be delivered with or apart from the shipment 114, and may be scanned in to electronic form by the enterprise and stored on the computer-readable storage medium 109 for subsequent processing. When a physical certificate of analysis is received, a duplicate form detection process implemented by the intra-enterprise specification compliance application 110 checks to ensure that an electronic version of the certificate of analysis has not already been received or stored for the shipment 114 and, if so, deletes the physical certificate or implements a process to confirm whether the values on the physical certificate are the same or different any stored values.

Regardless of whether the certificate of analysis 112 is communicated between the supplier and the enterprise in physical or electronic form, the intra-enterprise specification compliance application 110 on the specification compliance server 101 performs, during state (b), an automated or partially automated analysis on the certificate of analysis 112 to identified a certified value or certified values for one or more attributes associated with the ingredient.

Such an analysis may include, for example, performing an optical character recognition (OCR) process on the certificate of analysis 112. According to some implementations, values or ranges of values for particular attributes are determined when the specification compliance application 110 analyzes a region (or regions) of the certificate of analysis 112 that is known by the specification compliance application 110 to list attribute values, or particular attribute values.

A supplier-specific template may be used to map regions on the certificate of analysis 112 to corresponding attribute values. A supplier may, for example, supply a sample certificate of analysis that shows the absolute or relative position that attributes values will be listed on future certificates of analysis, and the specification compliance application 110 or a user of the application 110 may build a supplier-specific template based on the sample. The template can be created by importing the sample certificate of analysis, defining different zones on the sample certificate of analysis that represent attribute values, defining an order in which each zone is evaluated, and establishing correspondences between zones and attribute names. When actual certificates of analysis are received, the correspondence or mapping is used to appropriately extract attribute values from those certificates.

The supplier-specific templates stored on the specification compliance server 101 may specify that, for a particular supplier, a particular value for a particular attribute is shown in a particular region of a certificate of analysis that is provided by that supplier. The region may be defined in absolute terms, such as by defining a fixed position (e.g., fixed coordinates) on a page of a certificate of analysis that always lists a particular attribute value. The region may also be defined in relative terms, such as by expressing the position of a region of the certificate of analysis that lists a particular attribute, in terms of a position relative of another region of the certificate of analysis (e.g., “immediately below the logo” or “three inches to the right of the moisture content attribute value”) or in terms of a position relative to a feature of the page (e.g., “four inches below the header, one inch to the right of the left margin”).

The supplier-specific templates may be updated periodically, to ensure that erroneous attribute values are not input and used for performing intra-application specification compliance. For example, the templates may be reviewed and updated annually, or routinely after every N certificates of compliance have been received.

The templates may also be updated after determining that certain attribute values that have been automatically read from a certificate of analysis using a template fall outside the usual, normal, or acceptable range of values that are associated with the supplier, attribute, and/or the ingredient. Such a deviation may occur when a supplier's certificate of analysis format has changed without notice, and a value is read in, or an attempt is made to read in a value, for the wrong attribute. For instance, if a value of over “100” is read in for an attribute that is expressed as a percentage, or if a value that falls outside of a range of values is read in for an attribute that is restricted to the range (e.g., pH), such values may indicate to the specification compliance application 110 that the mapping or correspondence is out-of-date and requires updating or manual review.

In FIG. 1, a template for the supplier may indicate that a value for the attribute “purity,” is included in the certificate of analysis 112 in a region that is bounded by landmarks 115A-D. That region is scanned or read in using an OCR process to determine that, for the shipment 114, the “purity” attribute of ingredient (in the figure, “red wheat flour”) has a value 116 of “93%.” The automatic analysis may finish when one or more values or ranges of values has been read in, when all values or ranges of values listed on the certificate of analysis 112 have been read in, when all values or ranges of values that have corresponding specification values have been read in, or when one or more values or ranges of values listed on the certificate of analysis are determined to be erroneous or outside of the normal, usual or acceptable ranges.

Fewer than all of the attribute values may be read from the certificate of analysis 112. For instance, if a certificate of analysis includes an attribute, i.e., a “color” attribute or an “inspector name” attribute, that has no corresponding specification value, that value may be ignored, filtered, or otherwise excluded from further processing. Similarly, attribute values that are shown outside of defined OCR zones, or that fall outside upper or lower thresholds, may not be read in or processed.

While the process for generating templates and determining a value or range of values for different attributes listed on the certificate of analysis 112 has been described as an automated or partially automated process, in other implementations these processes may be performed manually, either fully or in part. For instance, a data entry clerk may review certificates of analysis 112 as they are received, and may review and manually enter attribute values into the specification compliance server 101. Manual entry of attribute values may also be initiated after automated processes have failed, or have determined that automatically obtained values may be erroneous or suspect. For instance, the specification compliance application may forward a certificate of analysis to a data entry clerk if an automatically obtained value falls outside of a normal, acceptable, or possible range.

During state (c), the enterprise accesses a specification that indicates a value or a range of values (referred to collectively as “specification values”) for one or more of the attributes. To obtain a specification value for the “purity” attribute, the document management server 104 selects a current specification associated with the supplier, shipment, and/or ingredient, from among multiple specifications that may be stored on the document management server 104. Specifications may be stored in client-specific tables or databases, as other types of electronic documents or files such as spreadsheets, or electronic versions of paper documents.

In FIG. 1, for example, the document management server 104 selects a contract 117 that is associated with the supplier and the ingredient, and transmits an electronic version of the contract 117 to the specification compliance server 101 over the networks 106. From the contract 117, the specification compliance server 101 determines that the specification value promised by the supplier for the ingredient value “red wheat flour” is “98%.” The electronic version of the contract 117 may be a look-up table that the specification compliance application 110 may query attribute names against in order to determine attribute values. Alternatively, the electronic version of the contract 117 may undergo a similar OCR process as the certificate of analysis 112, to determine attribute values by analyzing regions of the contract 117 in which the attribute value is known (or is expected) to be shown.

During state (d), the enterprise compares the value or range of values from the document, for each attribute, to the specification value or range of values for the attribute, to identify an extent to which the attribute in the particular shipment of the ingredient satisfies the specification. In doing so, the specification compliance server 101 determines that the “93%” value for the purity attribute reflected on the certificate of analysis 112 is lower than the “98%” specification value promised by the supplier, by “5%.”

A standard deviation or other normalized metric can be calculated based on the extent of any deviation, can optionally be aggregated with other data, and can be used to calculate a risk score for the supplier, the ingredient, the shipment, or the attribute. For instance, a deviation of “5%” can be input to a rule (e.g., rules 111) or a look-up table that is specific to the attribute, shipment, and/or supplier, to output a normalized value that scores the extent to which the shipment deviates, in terms of values that are not easily traceable back to a particular shipment and/or supplier, or to the enterprise. Selection of the appropriate attribute, shipment, and/or supplier-specific rule or look-up table may be a precursor operation to calculating the normalized metric.

During state (e), the enterprise automatically determines an action to be taken on the shipment 114, or takes an action on the shipment 114, based on the extent to which the shipment 114 satisfies or does not satisfy the specification. The action to be taken may also be indicated by the shipment, attribute, and/or supplier-specific rule or look-up table that is used to generate a normalized score.

If the shipment does not satisfy the specification (e.g., either by any extent, by an insignificant extent, or by a significant extent), the enterprise may, for example, reject the shipment 114, notify the supplier that the shipment 114 does not satisfy the specification (“is out of spec”), request that the supplier remediate the shipment 114, may notify an employee of the enterprise, may mark or flag the shipment 114 for further internal processing, may blend the ingredient included in the shipment 114 with ‘in spec’ ingredients from other shipments, may accept the shipment 114 anyway, or may take any number of other appropriate actions. If the shipment does satisfy the specification, the enterprise may accept the shipment 114, may notify an employee of the enterprise, may mark or flag the shipment 114, or may take another action.

A deviation may be considered significant or insignificant based on the identify of the supplier, or the type of ingredient, shipment, or attribute, and may be encoded in the rules 111. For instance, the rules 111 may specify multiple actions to be taken based on the extent to which the shipment 114 satisfies or deviates from the specification, where more drastic actions (such as the rejection of a shipment 114) may be taken for significant deviations, and actions that ultimately result in acceptance of the shipment 114 may be associated with insignificant deviations or the absence of a deviation.

In FIG. 1, the “5%” deviation between the specification value and the value listed in the certificate of analysis 112 is input to the rules 111. A rule (reflected in table 119) that is associated with the supplier, the shipment, or the ingredient indicates, for example, that deviations in the “purity” attribute of “1%” or less will result in an “accept” action. The fact that a deviation of “1%” or less ultimately results in the acceptance of the shipment 114 leads to the inference that, in the context of this particular supplier, ingredient, and shipment, such a deviation is considered to be insignificant.

The rules 111 also provide that deviations between “1%” and “4%” will result in a “remediate” action, and deviations of greater than “4%” will result in a “reject” action. Such rules reflect the fact that, in the context of this particular supplier, ingredient, and shipment, the significance of any deviation increases as the magnitude of the deviation increases over “1%”.

Because the deviation shown in FIG. 1 represents a “5%” deviation, the specification compliance server 101 determines that the corresponding action is a “reject” action, and transmits a message 120 to the shipment management server 105 to reject the shipment 114. This results, during state (f), in the enterprise's employees receiving a notice from the specification compliance application 110 to place the shipment 114 back on a truck 121, to be sent back to the supplier. The specification compliance application 110 may itself take action to reject the shipment, such by activating a conveyer belt to place the shipment 114 back on the truck, or by notifying a delivery service to return or not deliver the shipment 114.

The specification compliance server 101 may also transmit a message to the supplier server 102, to indicate that the shipment 114 is being rejected. Other actions may also be automatically initiated, such as a legal process to begin a claim against the supplier, an evaluation process to evaluate the performance of the supplier, or an accounting process to stop or prevent payment for the shipment.

Using the process illustrated in FIG. 1, an enterprise can automatically analyze a certificate of analysis for a shipment of an ingredient before or after the shipment is received, to identify attributes associated with the ingredient in the shipment. The analysis may result in the identification or determination of values, or of ranges of values, that are associated with different quality or purity attributes of the ingredient in the shipment.

The comparison of these values to the specification values allows the enterprise to determine or quantify the extent to which the shipment satisfies or deviates from the specification and, by extension, the extent to which the supplier has honored or failed to live up to their commitments. Depending on the nature or extent of any deviations between received attribute values and promised specification values, various actions may be taken on the shipment, or on future shipments from the supplier.

Further comparison of the values obtained from the certificate of analysis with attribute values generated by the enterprise may allow the enterprise to determine the extent to which the supplier-provided certificate of analysis is accurate. Such an analysis allows the enterprise to aggregate data across multiple suppliers, shipments, ingredients and attributes to generate a liars report that indicates the accuracy of the certified statements of various suppliers. Information identifying the extent to which a supplier's certificates of analysis are generally considered to be accurate may be used by the enterprise in supplier selection and evaluation processes, or may be normalized and shared with other enterprises that are considering doing business with the supplier.

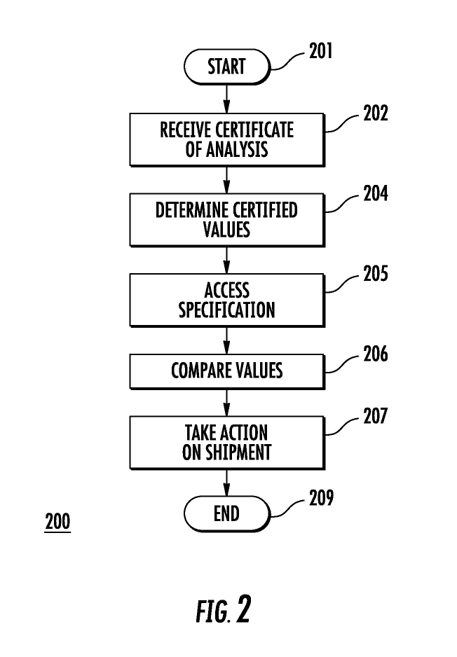

FIG. 2 is a flowchart of an exemplary process 200. Briefly, the process 200 includes receiving a document pertaining to particular shipment of an ingredient from a supplier, automatically determining, from the document, a value or a range of values for each of one or more attributes associated with the ingredient, accessing a specification that indicates a value or a range of values for each attribute, comparing, for each attribute, the value or range of values from the document to the specification value or range of values for the attribute, to identify an extent to which the attribute in the particular shipment of the ingredient satisfies the specification, and automatically taking action on the shipment based on the extent to which the shipment satisfies the specification.

In further detail, when the process 200 begins (201), a certificate of analysis or other document pertaining to particular shipment of an ingredient, is received from a supplier or agent of the supplier, such as an in-house or third-party laboratory (202). The certificate of analysis may be known by other names, such as a “certificate of compliance.” Information pertaining to the shipment may be obtained other ways as well, such as from shipping documents, through data sharing portals, or by testing or measurement performed by the enterprise.

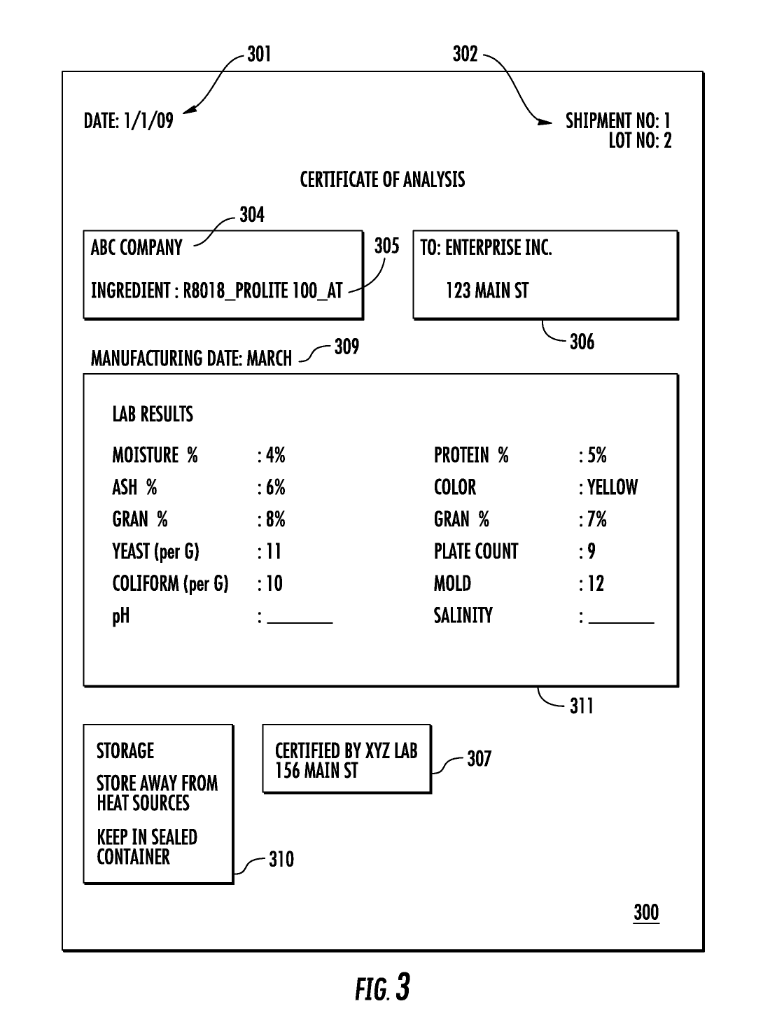

Referring ahead briefly, FIG. 3 depicts an example certificate of analysis 300. Among other information that may be included on this document, the certificate of analysis includes date information 301 that indicates when the certificate of analysis was prepared or provided to the enterprise, and/or when the shipment was sent or received. The shipment itself is uniquely identified by shipment information 302.

The certificate of analysis may include supplier information 304 that identifies the supplier of the ingredient, name information 305 that identifies the name of the ingredient (as commonly used or as assigned by the supplier), enterprise information 306 that identifies the recipient of the shipment, and preparer information 307 that identifies the entity that prepared the certificate of analysis 300 or that determined or validated some or all of the information that is shown on the certificate of analysis 300. The certificate of information 301 may include other information about the shipment or the ingredient, such as manufacturing information 309 or storage information 310.

The certificate of analysis 300 includes an attribute region 311 that shows the various attributes of the shipment of the ingredient 305, and values or ranges of values associated with some or all of the attributes. The attribute region 311 may include multiple attribute name/attribute value pairs. For example, the attribute region 311 shows that the attribute “moisture %” has an attribute value of “4%.”

Because the certificate of analysis may use a predefined format that is common to many different types of ingredients, attribute values may not be supplied for all attributes or blank or null values may be shown. On the certificate of analysis 300, for example, the attribute “pH” has no associated attribute value. In certain implementations, fewer than all of the attribute values shown on the certificate are analysis are used for performing specification compliance. A “color” attribute may be ignored, for example, if no corresponding specification value has been agreed upon by the supplier.

A value or a range of values is automatically determined from the document, for each of one or more attributes associated with the ingredient (204). Automatic determination of attribute values may include digitizing a certificate of analysis, performing an OCR process on the digitized certificate, and obtaining values shown in regions or zones of the certificate that, through analysis of previous or sample certificates of analysis from the supplier, are known by the enterprise to be associated with particular attributes or attribute values. Because different suppliers may use different certificates of analysis for the same ingredient, supplier-specific templates, or supplier-and-ingredient specific templates, may be used to locate values for particular attributes, from among the various types of information shown in a given certificate of analysis.

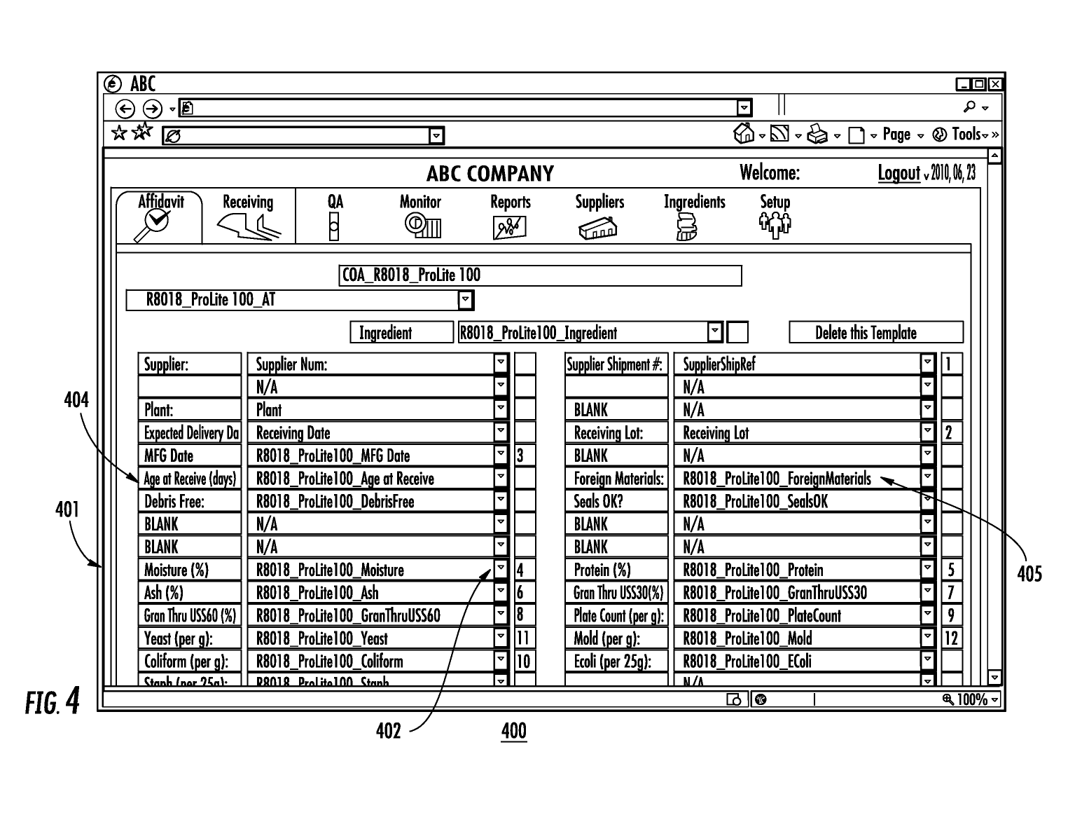

Referring ahead briefly, FIG. 4 is an example screenshot 400 of an intra-enterprise specification compliance application, in a state where some of the attribute values shown on the certificate of analysis 300 have been automatically read in and stored. The screenshot 400 lists several attributes (e.g., “moisture” attribute 401) and corresponding attribute values (e.g., attribute value “4” 402 for “moisture” attribute 401) that have been obtained by automatically analyzing the certificate of analysis 300. The fact that some attribute values are not obtained for several attributes (e.g., “Age at Receive” attribute 404 and “Foreign Materials” attribute 405) may indicate that these attributes are not included on the certificate of analysis, that no corresponding specification values exist for these attributes, that automatically obtained values fell outside upper and lower control limits, or that these attributes are not defined for the ingredient.

In alternative implementations, automatic determination of attribute values may include accessing a mapping that identifies portions of the certificate of analysis correspond to the various attribute values. When the certificate of analysis is (or includes) a spreadsheet, for example, the mapping may map cell references to corresponding attribute values. When the certificate of analysis is (or includes) a markup language file, such as an XML file, the mapping may map XML tags to corresponding attribute values.

The value or range of values may also be determined without using a certificate of analysis, such as where the enterprise queries a web service operated by the supplier to identify attributes and attribute values associated with a particular shipment. Alternatively, the enterprise may set up a web page that lists attribute names, and that allows the supplier to manually or automatically enter values, among other information, for a shipment of an ingredient. The supplier may be required to submit an e-affidavit after entering the values, to certify that they are accurate. The enterprise itself may also manually enter attribute values, either as a matter of routine or after an unsuccessful attempt has been made to automatically obtain these values.

Before the value or range of values is compared with specification values, the values may be checked to determine whether they fall outside usual, normal, or threshold values that are associated with a particular supplier and/or ingredient. A value of “37” for “pH,” for example, may indicate that an incorrect or non-corresponding value was read for the “pH” attribute. Incorrect values may be read, for example, when a document is incorrectly scanned in, or when additional or fewer attributes than normal are shown on a certificate of analysis, such as when the supplier changes the format of their standard certificate of analysis.

When values are determined to be out of bounds, the document may be processed again, or the document can be flagged for human review. Furthermore, a process for reviewing and updating any templates associated with the supplier may be initiated to confirm that the supplier's certificate of analysis format has not changed or cause the template to be updated. In addition to or instead of analyzing attribute values to determine whether the format of the certificate of analysis has changed, the changes in the position of other information on the certificate of analysis, such as logos, headers, or shipping information, can suggest the occurrence of format changes that require review of a supplier's template.

A specification is accessed, where the specification indicates a value or a range of values for each attribute is accessed (205). The specification values may be numeric values, characters or strings of characters, Boolean values (e.g., true/false, yes/no), or other types of values that quantitatively or qualitative describe an attribute of the ingredient that the supplier has committed to providing in the shipment. For a particular attribute, a single specification value may represent a desired value, upper acceptable range value, an upper value that defines the lower range of a warning track, a lower acceptable value, a lower value that defines the upper range of a warning track, or another value. Multiple specification values for a single attribute may define an upper and lower control limits that indicate range of acceptable values.

For each attribute, the value or range of values from the document is compared to the specification value or range of values for the attribute, to identify an extent to which the attribute in the particular shipment of the ingredient satisfies the specification (206). A standard deviation may be calculated for the supplier, the ingredient, the shipment or the attribute, based on any deviation, and one or more risk scores may be updated.

The extent to which the attribute satisfies or deviates from the specification may be quantified in many different ways. In some implementations, the value is quantified as a risk score that is particular to that supplier, ingredient, shipment and/or attribute, and that may be aggregated with other risk scores for the supplier, ingredient, shipment and/or attribute to tally a combined risk score.

The risk score may be expressed as a difference value that may be calculated by subtracting one of the certified value and the specification value from the other. The risk score may also (or instead) be expressed as a percentage value that may be calculated by dividing one of the certified value and the specification value by the other. The risk score can be expressed as a standard deviation value, in standard deviation units. The risk score may also be calculated using an algorithm or a look-up table that accepts the actual deviation amount as an input.

For instance, the risk score can be expressed in a normalized score that is calculated by, for example, inputting a difference value, percentage value, or standard deviation value into an algorithm or look-up table, to determine a normalized score that cannot be traced back to a particular recipient, supplier, ingredient, shipment or attribute. In one example, the risk score is normalized to a range of “1” to “5”, or “0” to “100,” where one end of the range corresponds to full satisfaction of the specification, and the other end of the range corresponds to a failure to satisfy the specification (e.g., deviation from the specification by more than a predefined amount). By normalizing the risk score, meaningful information about suppliers can be anonymized and shared by the enterprise, without revealing sensitive information that might put an enterprise at a disadvantage to a competitor.

Action is automatically taken on the shipment based on the extent to which the shipment satisfies the specification (207), thereby ending the process 200 (209). For example, the risk score or other quantified value can be input to a rule to determine an action that has been associated with the score or value. Other context information can also be used in conjunction with a risk score to determine the action to take on the shipment.

In the situation where certificates of analysis are provided to an enterprise in advance of the ingredient being shipped, a receiving department at the enterprise may be given a list of expected shipments that identifies those shipments that should be accepted and rejected. By indicating a corresponding action for each expected shipment, this report is helpful in the situation where a supplier sends an ‘out of spec’ ingredient despite being informed that the ingredient is ‘out of spec’ and should not be shipped.

The attribute may fully satisfy the specification when the value shown in a certificate of analysis matches or is within an acceptable range of a specification value. Full satisfaction of the specification may result in the shipment being accepted by the enterprise.

The attribute may satisfy the specification, yet the value shown in the certificate of analysis may be close to being ‘out of spec,’ by either being close to being too high or too low. These shipments, which are referred to as “warning track” satisfactory shipments, may be accepted. Additional actions may be taken on “warning track” satisfactory shipments to render the attribute closer to the specification value, such as by blending the ingredient with other shipments of ingredients or asking or warning the supplier to ship ingredients that are in better compliance with the specification.

The attribute may not satisfy the specification, yet the value shown in the certificate of analysis may be close to being ‘in spec.’ When a certificate of analysis indicates that one or more attributes are close to being ‘in spec,’ the shipment may be automatically accepted or rejected, a message may be generated to ask an employee of the enterprise such as a plant manager to make a decision as to accept or reject the shipment, the shipment may be put in an ‘on hold’ area of the enterprise, or a process may be automatically initiated to find a new supplier.

The attribute may not satisfy the specification, and may not be close to being ‘in spec.’ Significant deviation from the specification value for one or more of the attributes of the ingredients may result in the shipment being automatically rejected.

In some implementations, the set of business rules defines seven ranges, reflecting the spectrum of conditions that may occur in a particular shipment. These ranges may include an ‘out of spec, high—reject’ range of values, an ‘out of spec, high—ask’ range of values, an ‘inspect, warning track, high—accept’ range of values, an ‘accept’ value or range of values, an ‘inspect, warning track, low—accept’ range of values, an ‘out of spec, low—ask’ range of values, and an ‘out of spec, low—reject’ range of values.

Other information may also be used to determine whether or not to ultimately accept or reject a shipment. For example, the enterprise may store data describing qualitative or quantitative characteristics of the ingredient as observed on the loading dock, the results of independent laboratory evaluations or of in-house or third party quality assurance analysis. Furthermore, the enterprise may store downstream performance feedback regarding the performance of similar ingredients from the same supplier, or of similar ingredients with similar attribute values from the same supplier, as observed by downstream manufacturing or retail store operations, or by consumers.

When one or more attribute values of a particular shipment of an ingredient indicate the shipment is nearly ‘out of spec’ or nearly ‘in spec,’ this data can be used to determine whether or not to accept a shipment. For instance, if a shipment of an ingredient is nearly ‘in spec,’ data that indicates that a past shipment of an ingredient from the same supplier that was ‘out of spec,’ or nearly ‘in spec,’ exhibited wide retail store or consumer acceptance, the enterprise may choose to accept the shipment. Conversely, if a shipment of an ingredient is nearly ‘out of spec,’ data that indicates that a past shipment of an ingredient from the same supplier that was ‘in spec,’ or nearly ‘out of spec’ resulted in poor end-user feedback, the enterprise may choose to reject the shipment.

The enterprise may use a risk score for a particular supplier, ingredient, shipment or attribute to generate or alter one or more aggregated, normative metrics for the shipment, the supplier, the ingredient, or the attribute. The metric may quantify the deviation of the certificate of analysis attribute value from the desired specification value (or mean specification value) for the attribute, specified in standard deviation units. Where the enterprise performs additional quantitative or qualitative analysis of the shipment, the risk score may also quantify the deviation from the actual attribute value, measured by the enterprise, from the certificate of analysis value reported by the supplier.

In quantifying the deviation of all ingredients and attributes supplier or reported by the supplier, the score may reflect the credibility and reliability of the supplier, indicating, for instance, how far off the supplier's shipment was from the specification values, or how far off the supplier's certificate of analysis was from the actual attribute values. A second derivative of the risk score may reflect which suppliers are trending in positive or negative directions. The enterprise may use a supplier's risk score in their supplier selection and evaluation processes, allowing the enterprise to make the decision to choose a particular supplier based on more than price and the supplier's promised, future performance.

When a normative metric is calculated for a particular ingredient, the metric may quantify the average deviation of all attributes for the ingredient. Using this metric, the enterprise may determine, for instance, whether shipments of an ingredient are usually ‘in spec’ or ‘out of spec,’ regardless of supplier. According to some implementations, an overall risk score for a supplier and an overall risk score for an ingredient are updated whenever a shipment is received, based on the information from the latest shipment.

The updated risk scores may be used to generate color coded reports using the risk scores associated with each supplier, ingredient, shipment, or attribute, allowing the enterprise to better evaluate supplier compliance and supplier impact, and increasing visibility and accountability. For example, the color coded report may allow a manager at the enterprise to quickly identify suppliers that are the biggest problems, with respect to deviations from mean or desired specification values. In doing so, the extent to which individual suppliers are meeting a desired target specification may be measured through risk scores that average all deviations by the supplier. By comparing suppliers based on risk score instead of or in addition to price, an “apples-to-apples” qualitative comparison can be made by the evaluator before ordering an ingredient.

Instead of or in addition to analyzing the attributes of ingredients, a similar process to exemplary process 200 may also be used to analyze the attributes of suppliers to determine the extent to which suppliers have satisfied or deviated from a specification. For instance, documents (e.g., audit results) pertaining to the supplier of an ingredient may be received. From the document, a value or a range of values for each of one or more attributes associated with the supplier may be automatically determined (e.g., a date of a last audit). A specification that indicates a value or a range of values for each attribute (e.g., an audit frequency) is accessed and, for each attribute, the value or range of values from the document is compared to the specification value or range of values for the attribute. Based on this comparison an extent to which the attribute of the supplier satisfies the specification is determined. This extent may be used in the normal course of choosing and evaluating suppliers.

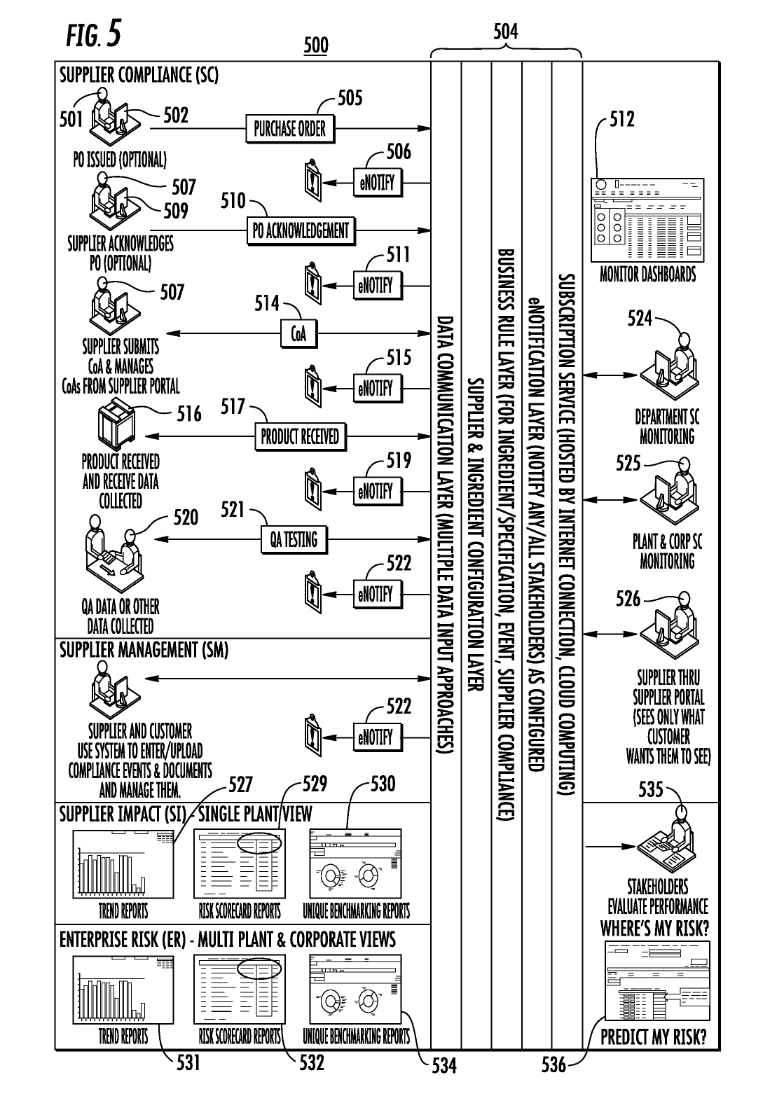

FIG. 5 is a diagram of an example system 500. An agent 501 of an enterprise uses a computer 502 to interface with a service 504, e.g., through a SaaS subscription, to optionally enter a purchase order 505 for an ingredient. The service 504 provides a notification 506 to an agent 507 of a supplier that is interfacing with the service 504 through a computer 509. The notification 506 to the agent 507 optionally triggers an automatically or manually-initiated acknowledgement 510 of the purchase order 505, which triggers the service 504 to provide a notification 511 of the acknowledgement to the enterprise.

Before or concurrent with shipping the ingredient, the agent 507 of the supplier transmits a certificate of authenticity (“CoA”) 514 to the service 504, triggering the service 504 to transmit a notification 515 to the supplier and/or the enterprise. When a shipment 516 of the ingredient is physically received by the enterprise, the agent 501 of the enterprise provides a notification 517 to the service 504, triggering the service 504 to provide a notification 519 of the receipt of the shipment 516 to the supplier.

The agent 501 may submit the shipment for quality assurance testing by a quality assurance agent 520 of the enterprise. Quality assurance data 521 collected from the quality assurance testing is provided to the service 504, triggering the service to transmit a notification 522 to the supplier.

Using the information sent to and received by the enterprise and supplier, the service 504 may provide dashboard interfaces 512 that provide the current status of a purchase order and/or shipment to an agent 524 that is monitoring the supply chain on behalf of a supply chain monitoring department of the enterprise, to an agent 525 that is monitoring the supply chain on behalf of a plant or corporate supply chain monitor for the enterprise, or to an agent 526 of the supplier. The dashboard 512 that is provided to the agent 526 may display limited information about the shipment, depending upon parameters that are defined by the enterprise.

The dashboards 512 may convey different types of information to the supplier and the enterprise. The information may include, for instance, trend reports 527 that show the trend of risk scores for a supplier, attribute, or ingredient, over a user-selectable period of time, as observed by a particular plant within an enterprise. Risk scores may also be used to develop risk scorecard reports 529 that rank different suppliers based on past shipments, and benchmarking reports 530 that compare the performance of suppliers to industry standards.

Risk scores from multiple plants associated with an enterprise can be aggregated to develop aggregated trend reports 531, aggregated risk scorecard reports 532, and aggregated benchmarking reports 534 that are not specific to a particular plant. Using this information, stakeholders can generate reports 536 that highlight and predict risk, based on the actual, observed performance of suppliers.

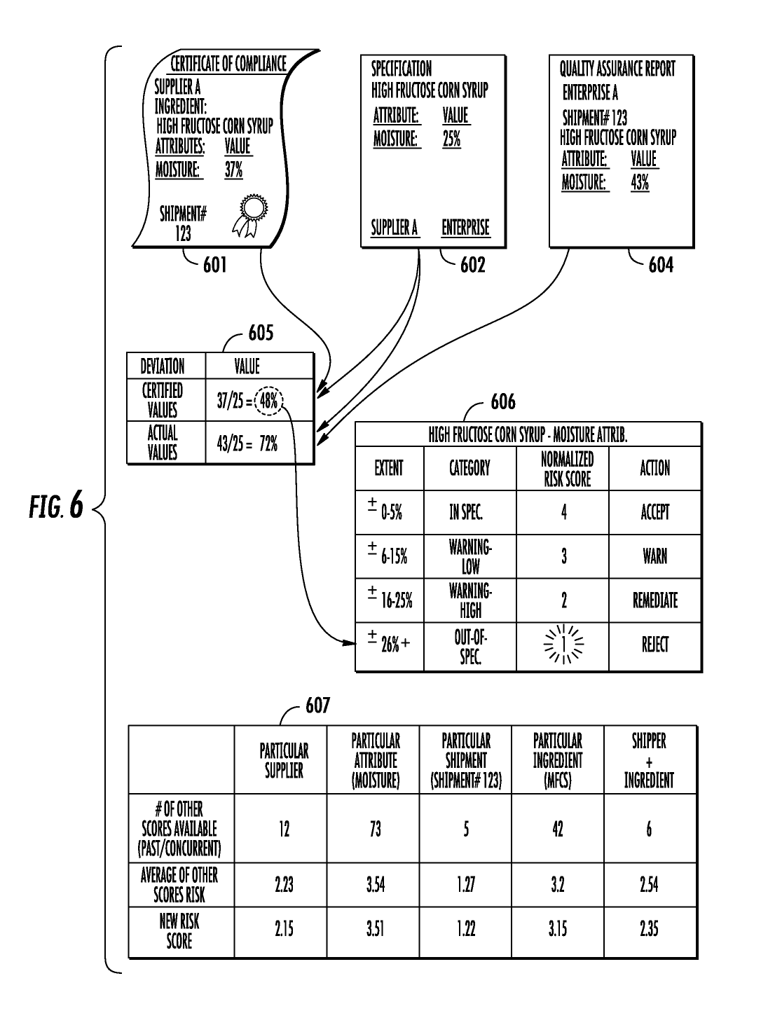

FIG. 6 shows an example of the calculation of risk scores for a sample shipment of an ingredient. A shipment of an ingredient may be associated with three or more different documents: a certificate of compliance 601 that is received from the supplier or an agent of the supplier (in the figure, “supplier A”), a specification 602 that details the promised characteristics of the ingredient or shipment, and quality assurance testing results 604 that the enterprise may generate after receiving the shipment. In this example, the certificate of compliance 601 indicates that, in this shipment (in the figure, “shipment #123”), the ingredient (in the figure, “high fructose corn syrup”) has a “moisture” attribute value of “37%.” The specification indicates that the “moisture” attribute is supposed to have a value of “25%,” while the quality assurance report indicates that the ingredient actually has a “moisture” attribute value of “43%.”

As shown in table 605, the specification value (“25%”) is compared with both the certification value (“37%”) and the actual value (“43%”) to determine the extent to which the ingredient deviates from the specification. In this example, the certified value deviates from the specification value by “48%,” and the actual value deviates from the specification value by “72%.”

A look-up table 606 is selected for the ingredient and attribute combination. The deviation between the certified value and the actual value is input to the look-up table 606 to classify the deviation, to generate a normalized risk score, and to determine an action to take upon the shipment. In FIG. 6, the table 606 indicates that a deviation of “48%” represents an “out-of-spec” condition, which is assigned a normalized risk score of “1.” The table 606 further indicates that the shipment should be rejected for being out-of-spec.

The normalized score of “1” for the moisture attribute in this particular shipment is used to update the risk scores associated with the supplier, the attribute, the shipment, the ingredient, and any appropriate combination thereof. For instance, the table 607 indicates that the particular shipment (“shipment #123”) had “5” other attributes that exhibited an average risk score of “1.27.” Factoring in the normalized risk score of “1” for the moisture attribute, the risk score for the particular shipment drops to “1.22.”

The risk score for the particular shipment may be used to update the risk score for the supplier. For instance, the table 607 indicates that the particular supplier (“supplier A”) previously delivered “12” other shipments, with an average risk score of “2.23.” Factoring in the risk score of “1.22” for this shipment, the risk score for the supplier drops to “2.15.” In a similar manner, the risk score for the “moisture” attribute falls to “3.51,” and the risk score for the ingredient “high fructose corn syrup” falls to 3.15.

Risks scores can be calculated for various shipment, attribute, ingredient, and supplier combinations. For instance, table 606 indicates that the particular supplier (“supplier A”) shipped “6” previous shipments of this particular ingredient (“high fructose corn syrup”), with an average risk score of 2.54. Factoring in the risk score of “1.22” for this shipment, the risk score for the combined supplier and ingredient combination falls to “2.35.”

A number of implementations have been described. Nevertheless, it will be understood that various modifications may be made without departing from the spirit and scope of the disclosure. For example, various forms of the flows shown above may be used, with steps re-ordered, added, or removed.

Embodiments and all of the functional operations described in this specification can be implemented in digital electronic circuitry, or in computer software, firmware, or hardware, including the structures disclosed in this specification and their structural equivalents, or in combinations of one or more of them. Embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal that is generated to encode information for transmission to suitable receiver apparatus.

A computer program (also known as a program, software, software application, script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a tablet computer, a mobile telephone, a personal digital assistant (PDA), a mobile audio player, a Global Positioning System (GPS) receiver, to name just a few. Computer readable media suitable for storing computer program instructions and data include all forms of non volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments can be implemented in a computing system that includes a back end component, e.g., as a data server, or that includes a middleware component, e.g., an application server, or that includes a front end component, e.g., a client computer having a graphical user interface or a Web browser through which a user can interact with an implementation, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the disclosure or of what may be claimed, but rather as descriptions of features specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Particular embodiments have been described. Other embodiments are within the scope of the following claims. For example, the steps recited in the claims can be performed in a different order and still achieve desirable results.

What is claimed is:

1. A computer-implemented method comprising:
receiving a document pertaining to particular shipment of an ingredient from a supplier;
automatically determining, from the document, a value or a range of values for each of one or more attributes associated with the ingredient;
accessing a specification that indicates a value or a range of values for each attribute;
comparing, for each attribute, the value or range of values from the document to the specification value or range of values for the attribute, to identify an extent to which the attribute in the particular shipment of the ingredient satisfies the specification; and
automatically taking action on the shipment, by one or more computers, based on the extent to which the shipment satisfies the specification.

2. The method of claim 1, wherein the document comprises a certificate of analysis.

3. The method of claim 1, wherein the attributes comprise quality attributes or purity attributes associated with the particular shipment of the ingredient.

4. The method of claim 1, further comprising calculating a risk score for one or more of the supplier, the ingredient, the particular shipment, and the attribute, based on the extent to which the attribute in the particular shipment of the ingredient satisfies the specification.

5. The method of claim 1, wherein automatically determining, from the document, a value or a range of values for each of one or more attributes associated with the ingredient further comprises:
accessing a template that is specific to the supplier, wherein the template maps regions of the document to attribute values; and performing an optical character recognition process on the document using the template.

6. The method of claim 1, further comprising:
determining an actual value or range of values for one or more attributes;
comparing the actual value or range of values to the value or range of values from the document, to identify an extent to which the value or range of values from the document deviates from the actual value; and
generating a report that identifies the extent to which the value or range of values from the document deviates from the actual value.

7. The method of claim 1, wherein the attribute comprises a moisture content attribute.

8. The method of claim 1, wherein comparing, for each attribute, the value or range of values from the document to the specification value or range of values for the attribute, further comprises comparing the value or range of values from the document to an “out of spec, high” range of values, a “warning track, high” range of values, an “accept” range of values, a “warning track, low” range of values, and an “out of spec, low” range of values.

9. A system comprising:
one or more computers; and
a computer-readable medium coupled to the one or more computers having instructions stored thereon which, when executed by the one or more computers, cause the one or more computers to perform operations comprising:
receiving a document pertaining to particular shipment of an ingredient from a supplier;
automatically determining, from the document, a value or a range of values for each of one or more attributes associated with the ingredient;
accessing a specification that indicates a value or a range of values for each attribute;
comparing, for each attribute, the value or range of values from the document to the specification value or range of values for the attribute, to identify an extent to which the attribute in the particular shipment of the ingredient satisfies the specification; and
automatically taking action on the shipment based on the extent to which the shipment satisfies the specification.

10. The system of claim 9, wherein the document comprises a certificate of analysis.

11. The system of claim 9, wherein the attributes comprise quality attributes or purity attributes associated with the particular shipment of the ingredient.

12. The system of claim 9, wherein the operations further comprise calculating a risk score for one or more of the supplier, the ingredient, the particular shipment, and the attribute, based on the extent to which the attribute in the particular shipment of the ingredient satisfies the specification.

13. The system of claim 9, wherein automatically determining, from the document, a value or a range of values for each of one or more attributes associated with the ingredient further comprises:
accessing a template that is specific to the supplier, wherein the template maps regions of the document to attribute values; and
performing an optical character recognition process on the document using the template.

14. The system of claim 9, wherein the operations further comprise:
determining an actual value or range of values for one or more attributes;
comparing the actual value or range of values to the value or range of values from the document, to identify an extent to which the value or range of values from the document deviates from the actual value; and
generating a report that identifies the extent to which the value or range of values from the document deviates from the actual value.

15. The system of claim 9, wherein the attribute comprises a moisture content attribute.

16. The system of claim 9, wherein comparing, for each attribute, the value or range of values from the document to the specification value or range of values for the attribute, further comprises comparing the value or range of values from the document to an “out of spec, high” range of values, a “warning track, high” range of values, an “accept” range of values, a “warning track, low” range of values, and an “out of spec, low” range of values.

17. A computer storage medium encoded with a computer program, the program comprising instructions that when executed by data processing apparatus cause the data processing apparatus to perform operations comprising:
receiving a document pertaining to particular shipment of an ingredient from a supplier;
automatically determining, from the document, a value or a range of values for each of one or more attributes associated with the ingredient;
accessing a specification that indicates a value or a range of values for each attribute;
comparing, for each attribute, the value or range of values from the document to the specification value or range of values for the attribute, to identify an extent to which the attribute in the particular shipment of the ingredient satisfies the specification; and
automatically taking action on the shipment based on the extent to which the shipment satisfies the specification.

18. The medium of claim 17, wherein the operations further comprise calculating a risk score for one or more of the supplier, the ingredient, the particular shipment, and the attribute, based on the extent to which the attribute in the particular shipment of the ingredient satisfies the specification.

19. The medium of claim 17, wherein the operations further comprise:
determining an actual value or range of values for one or more attributes;
comparing the actual value or range of values to the value or range of values from the document, to identify an extent to which the value or range of values from the document deviates from the actual value; and
generating a report that identifies the extent to which the value or range of values from the document deviates from the actual value.

20. The medium of claim 17, wherein comparing, for each attribute, the value or range of values from the document to the specification value or range of values for the attribute, further comprises comparing the value or range of values from the document to an “out of spec, high” range of values, a “warning track, high” range of values, an “accept” range of values, a “warning track, low” range of values, and an “out of spec, low” range of values.
